(19) United States
(12) Patent Application Publication
(10) Pub. No.: US 2014/0019219 A1
(43) Pub. Date: Jan. 16, 2014

(54) Regulating Impression Frequency in Content Display

(71) Applicants: Roshan Fernandes, Mumbai (IN); Bindu Mary Oommen, Hyderabad (IN)

(72) Inventors: Roshan Fernandes, Mumbai (IN); Bindu Mary Oommen, Hyderabad (IN)

(73) Assignee: GOOGLE INC., Mountain View, CA (US)

(21) Appl. No.: 13/549,022

(22) Filed: Jul. 13, 2012

(51) Int. Cl. G06Q 30/00

(52) U.S. Cl. 705/14.4

(57) ABSTRACT

Impression frequency of displayed content may be regulated by data processing apparatus by receiving from a content sponsor content items and information relating to an impression frequency with which one or more of the content items is to be displayed a viewer, maintaining a history of content items displayed to the viewer, receiving a request for content to be displayed to the viewer, selecting a content item from among the received content items based at least in part on the received impression frequency information and the viewer's maintained history, and providing the selected content item for presentation.

### BACKGROUND

This specification relates to regulating the frequency of impressions of content items (e.g., advertisements) presented to users in a display environment. Examples of display environments include electronic publications such as webpages accessible via a web browser application executing on a computer system that has connectivity with the Internet, on a point-of-sale kiosk, a dynamic billboard, a video stream, or, more generally, on any appropriate display in essentially any suitable context or environment. In whatever display content sponsoring context or environment, an impression of a certain content item is said to occur for each instance that that same content item is presented to a consumer, user or other viewer.

Resource providers (e.g., publishers such as web site publishers) may include content such as content sponsoring in their respective publications to help financially support their operations. Some resource providers do not maintain a content sponsoring (e.g., advertising) infrastructure, and thus depend on third party content sponsor serving companies to recruit content sponsors and to serve content items to the resource providers' sites. Third party content sponsor serving companies can, depending on various factors, control which content items are displayed to which users and under what circumstances.

### SUMMARY

This specification describes technologies relating to regulating the frequency of impressions of content items presented to users in a display content sponsoring environment, for example, to a human surfing the Internet and viewing webpages that host content items or to a consumer standing in a check-out line in a store.

Implementations may include corresponding systems, apparatus, methods and computer programs, configured to perform the actions of the methods and encoded on computer storage devices or other machine-readable articles.

In an implementation, information is received at a content item serving system from a content sponsor. The received information includes a plurality content items and information relating to an impression frequency with which one or more of the content items are to be served by the content item serving system for presentation to a viewer. The content item serving system maintains a history of content items served by the content item serving system for presentation to the viewer. The content item serving system receives a request for content to be served by the content item serving system for presentation to the viewer. At the content item serving system, a content item is selected from among the plurality of received content items based at least in part on the received impression frequency information and the viewer's maintained history. The selected content item is provided by the content item serving system for presentation to the viewer.

Information relating to impression frequency may comprise a skip impression parameter that specifies a quantity of different content item impressions to present before presenting a same content item again to the viewer. Alternatively, or in addition, information relating to impression frequency may comprise a set frequency parameter that specifies a quantity of impressions of a same content item to present in succession to the viewer.

Impression frequency information received from the content sponsor may specify variable impression frequencies based at least in part on one or more factors relating to the viewer. Such one or more factors relating to the viewer may include one or more of demographic information, psychographic information, external factors, content context, content popularity, viewer geographic location, and user supplied information.

All of the content items presented to the viewer may originate with a same content sponsor. Alternatively, one or more of the content items presented to the viewer may originate with different content sponsors. A content item may be an advertisement to be presented on webpage. The content sponsor may be an advertiser.

Any or all of the foregoing may be implemented as a computer-implemented method that is performed by data processing apparatus controlled by an advertising serving company.

Particular implementations of the subject matter described in this specification may be configured to realize various potential advantages. For example, by enabling a content sponsor to set parameters that are used to regulate content item impression frequency, content item effectiveness may be enhanced. In addition, by providing content sponsors with the ability to specify parameters such as a skip impression parameter (e.g., a quantity of content item impressions to skip before displaying that same content item again to the same viewer) and/or a set frequency parameter (e.g., a quantity of content item impressions to display in a row to the same viewer), content sponsors may fine tune their respective content item campaigns such that content items are displayed with sufficient and/or varying frequency to impart the desired consumer recall effect while, at the same time, are prevented from being displayed overly frequently to the point of annoying consumers due to tiresome repetition. As a result, effectiveness of content items tends to be increased.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 shows an example environment in which a content item slot in a publication is reserved to receive and display a content item.

FIG. 2 is a flowchart of an example process in which a skip impression parameter is used to manage display of content items to a viewer.

FIG. 3 is a flowchart of an example process in which a set frequency parameter is used to manage display of content items to a viewer.

FIG. 4 is a flowchart of an example process in which both skip impression and set frequency parameters are used to manage display of content items to a viewer.

FIG. 5 shows an example of a computer device and a mobile computer device that can be used to implement the technologies described herein.

Like reference numbers and designations in the various drawings indicate like elements.

### DETAILED DESCRIPTION

The technologies described here may be implemented to provide an environment in which content sponsors, for example, operating in conjunction with a content item serving company, may regulate the frequency of impressions of a particular content item to the same viewer. Such regulation may be realized, for example, by providing the content sponsor with either or both of (i) a skip impression parameter that, for each of the content sponsor's content items, allows the content sponsor to specify a quantity of different content item impressions to display before displaying that same content item creative again to the same viewer, and/or (ii) a set frequency parameter that, for each of the content sponsor's content items, allows the content sponsor to specify a quantity of content item impressions to display in a row to the same viewer. The skip impression and set frequency parameters can be used separately or in combination, and further can be applied in a content item rotation context in which the content item serving company chooses from and rotates among the content sponsor's universe of content items. The viewer's identity can be determined in any of a variety of ways including by soliciting viewer input, using a cookie or other token mechanism, biological recognition techniques or any other suitable means.

### Example Operating Environment

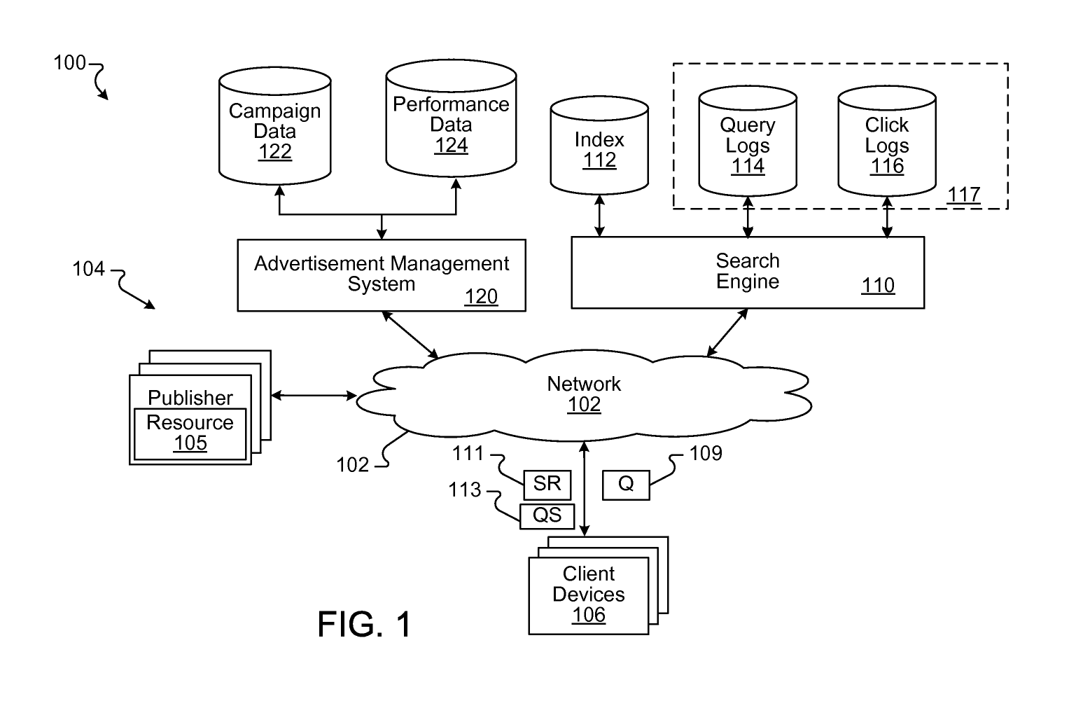

FIG. 1 is a block diagram of an example environment 100 in which various aspects of the subject matter described here may be implemented. A computer network 102, such as a local area network (LAN), wide area network (WAN), the Internet, or a combination thereof, connects resource provider web sites 104, user devices 106, and the search engine 110, and an advertisement management system 120. The online environment 100 may include many thousands of resource provider web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content resource provider, which is an entity that controls, manages and/or owns the website 104.

A resource is any data that can be provided by the resource provider 104 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as JavaScript scripts).

A user device 106 is an electronic device that is under the control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

To facilitate searching of these resources 105, the search engine 110 identifies the resources by crawling the resource provider web sites 104 and indexing the resources provided by the resource provider web sites 104. The indexed and, optionally, cached copies of the resources, are stored in an index 112.

The user devices 106 submit search queries 109 to the search engine 110. The search queries 109 are submitted in the form of a search request that includes the search request and, optionally, a unique identifier that identifies the user device 106 that submits the request. The unique identifier can be data from a cookie stored at the user device, or a user account identifier if the user maintains an account with the search engine 110, or some other identifier that identifies the user device 106 or the user using the user device.

In response to the search request, the search engine 110 uses the index 112 to identify resources that are relevant to the queries. The search engine 110 identifies the resources in the form of search results 111 and returns the search results to the user devices 106 in search results page resource. A search result is data generated by the search engine 110 that identifies a resource that satisfies a particular search query, and includes a resource locator for the resource. An example search result can include a web page title, a snippet of text extracted from the web page, and the URL of the web page.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device according to the order.

The user devices 106 receive the search results pages and render the pages for presentation to users. In response to the user selecting a search result at a user device 106, the user device 106 requests the resource identified by the resource locator included in the selected search result. The resource provider of the web site 104 hosting the resource receives the request for the resource from the user device 106 and provides the resource to the requesting user device 106.

In some implementations, the queries 109 submitted from user devices 106 are stored in query logs 114. Click data for the queries and the web pages referenced by the search results are stored in click logs 116. The query logs 114 and the click logs 116 define search history data 117 that include data from and related to previous search requests associated with unique identifiers. The click logs define actions taken responsive to search results provided by the search engine 110. The query logs 114 and click logs 116 can be used to map queries submitted by the user devices to web pages that were identified in search results and the actions taken by users (i.e., that data are associated with the identifiers from the search requests so that a search history for each identifier can be accessed). The click logs 116 and query logs 114 can thus be used by the search engine to determine the sequence of queries submitted by the user devices, the actions taken in response to the queries, and how often the queries are submitted.

The advertisement management system 120 facilitates the provisioning of content items with the resources 105. In particular, the advertisement management system 120 allows content sponsors to define targeting rules that take into account attributes of the particular user to provide targeted content items for the users. Example targeting rules include keyword targeting, in which content sponsor provide bids for keywords that are present in either search queries or webpage content. Content items that are associated with keywords having bids that result in an advertisement slot being awarded in response to an auction are selected for displaying in the advertisement slots.

When a user of a user device 106 selects an advertisement, the user device 106 generates a request for a landing page of the advertisement, which is typically a webpage of the content sponsor. For example, the resource providers 104 may include content sponsors, each having hosting respective web pages, some of which are landing pages for the content items of the content sponsors.

These targeted content items can be provided for many different resources, such as the resources 105 of the resource providers 104, and on a search results page resource. For example, a resource 105 from a resource provider 104 includes instructions that cause the user device to request content items from the advertisement management system 120. The request includes a resource provider identifier and, optionally, keyword identifiers related to the content of the resource 105. The advertisement management system 120, in turn, provides targeted content items to the particular user device.

With respect to a search results page, the user device renders the search results page and sends a request to the advertisement management system 120, along with one or more keywords related to the query that the user provide to the search engine 110. The advertisement management system 120, in turn, provides targeted content items to the particular user device.

The advertisement management system 120 includes a data storage system that stores campaign data 122 and performance data 124. The campaign data 122 stores content items, targeting information, and budgeting information for content sponsors. The performance data 124 stores data indicating the performance of the content items that are served. Such performance data can include, for example, click through rates for content items, the number of impressions for content items, and the number of conversions for content items. Other performance data can also be stored.

The campaign data 122 and the performance data 124 are used as input parameters to an advertisement auction. In particular, the advertisement management system 120, in response to each request for content items, conducts an auction to select content items that are provided in response to the request. The content items are ranked according to a score that, in some implementations, is proportional to a value based on an advertisement bid and one or more parameters specified in the performance data 124. The highest ranked content items resulting from the auction are selected and provided to the requesting user device.

### Skip Impression Parameter

The skip impression parameter is a content sponsor-settable parameter (e.g., via content sponsor's control panel webpage provided by an content item serving company) that enables that content sponsor to specify a quantity of different content item impressions for each content item creative that will be displayed in between display of that same content item creative from the same content item serving company to the same user. The intervening content item impressions may be either from the same or different content sponsors. For example, the Acme Widget Co., as a content sponsor, could provide a content item creative relating to a three-lobed widget and information specifying a skip impression parameter of, e.g., four. The content item serving company would then use that information when serving the Acme Widget Co.'s content item creative to viewers. For example, assume Viewer Bob surfs to a web page that has an available content item slot, which causes the content item serving company to select and provide for display the Acme Widget Co.'s three-lobed widget content item. In doing so, the content item serving company would remember the identity of the specific content item viewed by Viewer Bob and, in choosing and delivering content item creative in the future for Viewer Bob, the content item serving company would make sure that the three-lobed widget content item was not displayed again to Viewer Bob until four other, different content items item have been served by the content item serving company and displayed to Viewer Bob in the interim.

Potentially, this skip impression limitation could apply even if Viewer Bob walked away from the display screen or logged off from his computer system and did not resume for another hour, day, week or even a month or longer. That is, the content item serving company could keep track of Viewer Bob's skip impression count for the three-lobed widget content item (and, for that matter, for any and all other content items having skip impression parameters and for which Viewer Bob had a viewing history). Consequently, in this manner, the Acme Widget Co. is provided with a tool to manage, and thus help prevent, Viewer Bob from becoming annoyed at having to view the three-lobed widget content item too frequently.

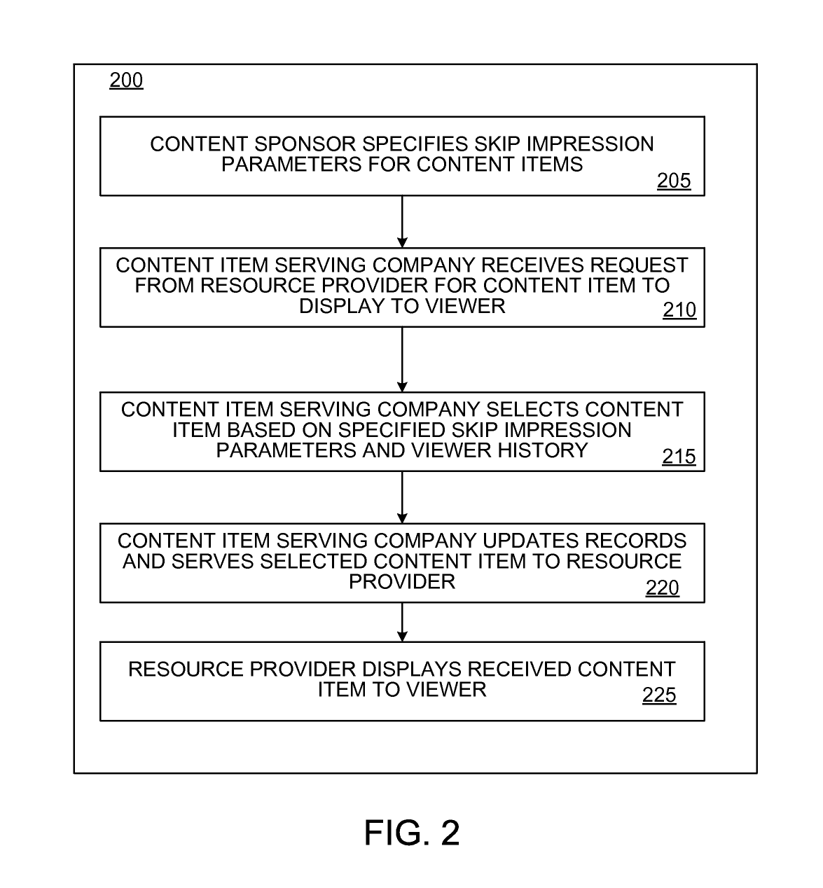

FIG. 2 is a flowchart of an example process 200 for implementing a skip impression parameter to manage a user's viewing of content items. At 205, the content sponsor specifies a skip impression parameter for one or more of its content items. Optionally, the specified skip impression parameter can be the same for all users or can vary with user-dependent factors such as user demographics, user geo-location, user psychographics, user history, external factors, user-supplied information, the nature or context of the content items and the like. In addition, each content item can be assigned an individually tailored skip impression parameter or groups of content items all can be assigned the same skip impression parameter.

At 210, the content item serving company receives a request from a resource provider for a content item to display to a specific viewer. At 215, the content item serving company, which has access to the skip impressions parameters specified by the content sponsor, and which maintains each viewer's viewing history (e.g., keeps a running count of which content items have been displayed to which viewers and at what frequency), makes a decision based on that information about which content item to select to provide to the resource provider for display to the viewer.

After making the decision, the content item serving company at 220 delivers the selected content item to the resource provider and updates its records about which content items have been displayed to which viewers and at what frequency. At 225, the resource provider displays the received content item to the viewer.

### Set Frequency Parameter

The set frequency parameter is a content sponsor-settable parameter (e.g., via content sponsor's control panel webpage provided by a content item serving company) that enables that content sponsor to specify a quantity of times in succession that a content item will be displayed to a same viewer (i.e., consecutive impressions) by the same content item serving company. Using the example above, the Acme Widget Co. could specify that the three-lobed widget content item have a set frequency parameter of, e.g., five. In that case, the content item serving company, when serving content items to Viewer Bob, would choose content items for delivery to ensure that the three-lobed widget content item was displayed to Viewer Bob five times in succession, even if Viewer Bob stopped interacting or viewing for an indefinite period of time, before any other, different content items were displayed to Viewer Bob.

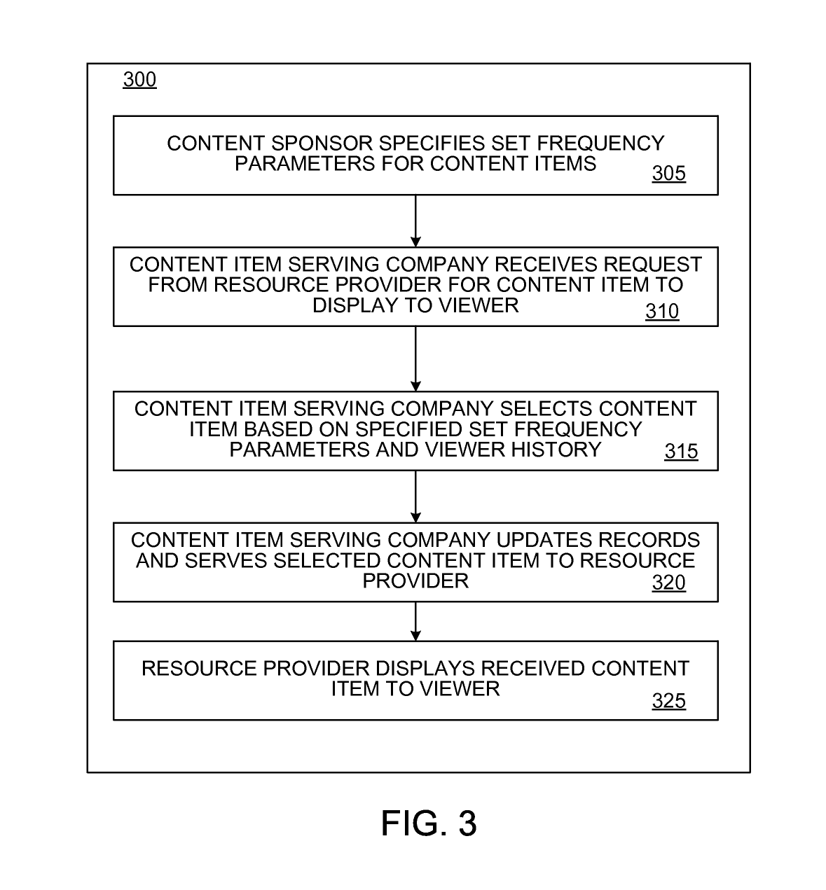

FIG. 3 is a flowchart of an example process 300 for implementing a set frequency parameter to manage a user's viewing of content items. At 305, the content sponsor specifies a set frequency parameter for one or more of its content items. Optionally, the specified set frequency parameter can be the same for all users or can vary with user-dependent factors such as user demographics, user geo-location, user psychographics, user history, external factors, user-supplied information, the nature or context of the content items and the like. In addition, each content item can be assigned an individually tailored set frequency parameter or groups of content items all can be assigned the same set frequency parameter.

At 310, the content item serving company receives a request from a resource provider for a content item to display to a specific viewer. At 315, the content item serving company, which has access to the set frequency parameters specified by the content sponsor, and which maintains each viewer's viewing history (e.g., keeps a running count of which content items have been displayed to which viewers and at what frequency), makes a decision based on that information about which content item to select to provide to the resource provider for display to the viewer.

After making the decision, the content item serving company at 320 delivers the selected content item to the resource provider and updates its records about which content items have been displayed to which viewers and at what frequency. At 325, the resource provider displays the received content item to the viewer.

### Variations

The skip impression parameter and the set frequency parameter can be used in conjunction, e.g., to specify that a certain content item creative is viewed by the same user, say, 3 times in a row (that is, the set frequency parameter is set to three) but then not viewed again by that same viewer until 10 impressions of different content item creative are displayed to that same viewer (that is, the skip impression parameter is set to 10).

The skip impression and/or set frequency parameters can be used in the content item rotation context in which the content item serving company has access to all of a content sponsor's content items and selects and rotates among them. In that case, all of the content items displayed to a same viewer would come from the same content sponsor, including the content items appearing as intervening content item impressions used for a skip impression parameter.

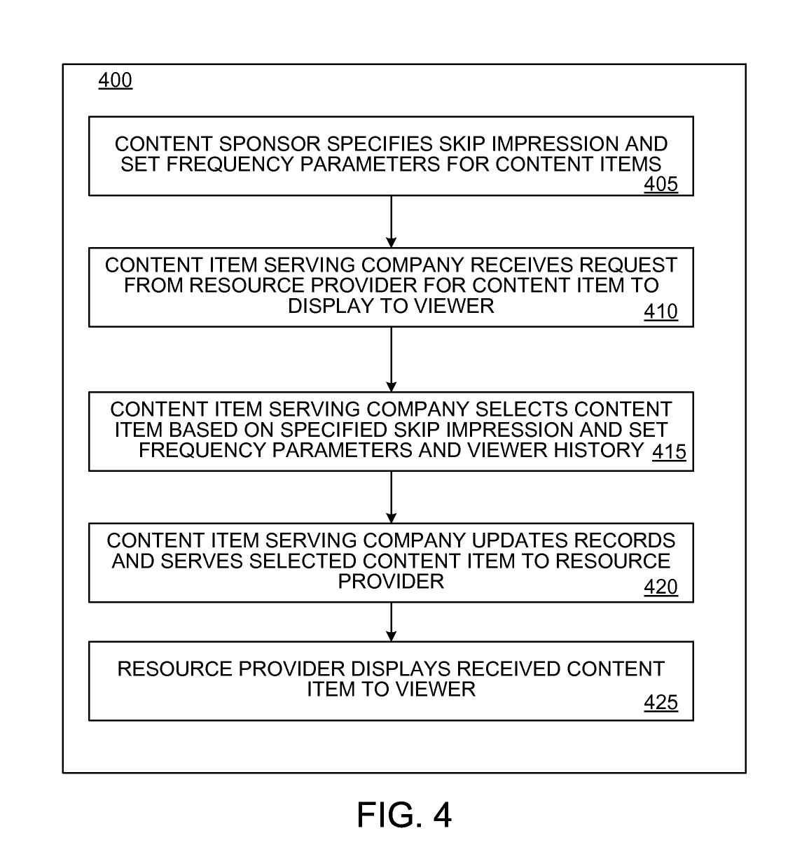

FIG. 4 is a flowchart of an example process 400 for concurrently implementing set frequency and skip impression parameters to manage a user's viewing of content items. At 405, the content sponsor specifies both set frequency parameters and skip impression parameters for a set of content items. Optionally, the specified set frequency parameters, and/or the specified skip impression parameters, can be the same for all users or can vary with user-dependent factors such as user demographics, user geo-location, user psychographics, user history, external factors, user-supplied information, the nature or context of the content items and the like. In addition, each content item can be assigned an individually tailored set frequency parameter and/or skip impression parameter, or groups of content items all can be assigned the same set frequency/skip impression parameters.

At 410, the content item serving company receives a request from a resource provider for a content item to display to a specific viewer. At 415, the content item serving company, which has access to the set frequency and skip impressions parameters specified by the content sponsor, and which maintains each viewer's viewing history (e.g., keeps a running count of which content items have been displayed to which viewers and at what frequency), makes a decision based on that information about which content item to select to provide to the resource provider for display to the viewer.

After making the decision, the content item serving company at 420 delivers the selected content item to the resource provider and updates its records about which content items have been displayed to which viewers and at what frequency. At 425, the resource provider displays the received content item to the viewer.

The skip impression and/or set frequency parameters can be used not only with regard to the same content item but also with similar content items—that is, different versions of otherwise the same content item. For example, the Acme Widget Co. could provide two different versions of the three-lobed widget content item (e.g., Creative1 and Creative2) both from the same content sponsor and both relating to the same product, but being slightly different in appearance, tone, message or the like. A skip impression parameter and/or a set frequency parameter could then be used to manage display of Creative1 and Creative2 to Viewer Bob as desired by the content sponsor.

Additional Implementation Details

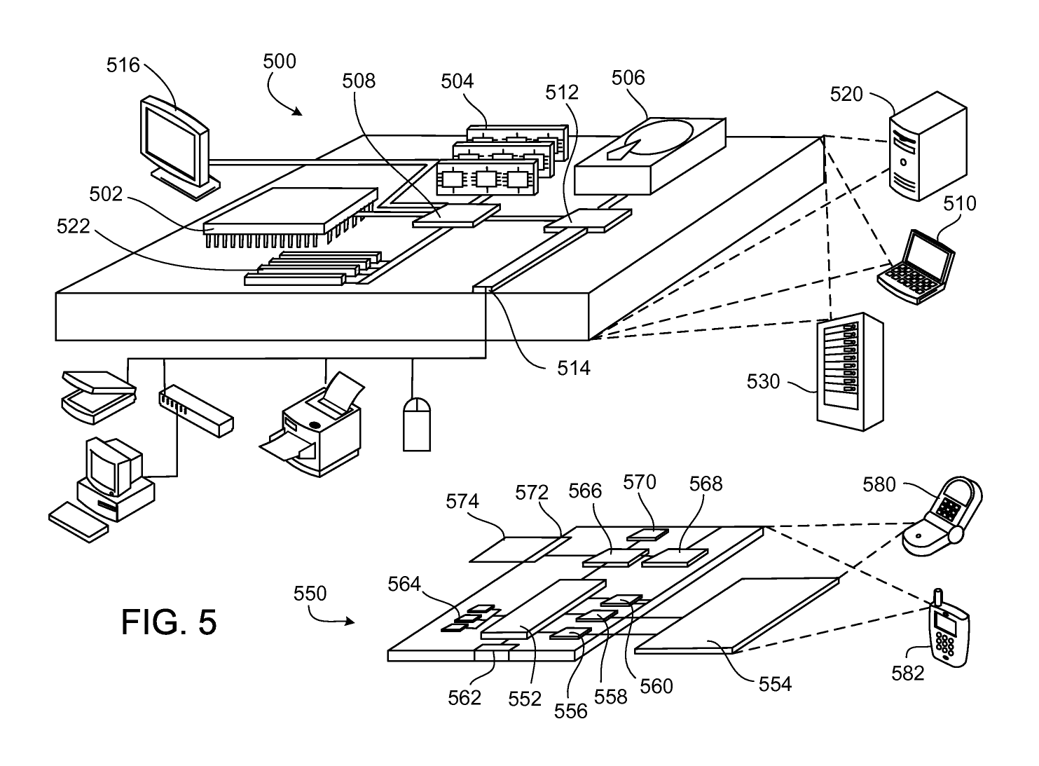

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 522, and a low speed interface 512 connecting to low speed bus 514 and storage device 506. Each of the components 502, 504, 506, 508, 522, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 522, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 530. In addition, it may be implemented in a personal computer such as a laptop computer 510. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving at a content item serving system from a content sponsor a plurality content items and information relating to an impression frequency with which one or more of the content items is to be served by the content item serving system for presentation to a viewer;
maintaining at the content item serving system a history of content items served by the content item serving system for presentation to the viewer;
receiving at the content item serving system a request for content to be served by the content item serving system for presentation to the viewer;
selecting at the content item serving system a content item from among the plurality of received content items based at least in part on the received impression frequency information and the viewer's maintained history; and
providing by the content item serving system the selected content item for presentation to the viewer.

2. The method of claim 1 in which the information relating to impression frequency comprises a skip impression parameter that specifies a quantity of different content item impressions to present before presenting a same content item again to the viewer.

3. The method of claim 1 in which the information relating to impression frequency comprises a set frequency parameter that specifies a quantity of impressions of a same content item to present in succession to the viewer.

4. The method of claim 1 in which the information relating to impression frequency comprises both (i) a skip impression parameter that specifies a quantity of different content item impressions to present before presenting a same content item again to the viewer, and (ii) a set frequency parameter that specifies a quantity of impressions of a same content item to present in succession to the viewer.

5. The method of claim 1 in which all of the content items presented to the viewer originate with a same content sponsor.

6. The method of claim 1 in which one or more of the content items presented to the viewer originate with different content sponsors.

7. The method of claim 1 in which a content item comprises an advertisement to be presented on webpage.

8. The method of claim 1 in which the content sponsor comprises an advertiser.

9. The method of claim 1 in which the method is performed by data processing apparatus controlled by an advertising serving company.

10. The method of claim 1 in which impression frequency information received from the content sponsor specifies variable impression frequencies based at least in part on one or more factors relating to the viewer.

11. The method of claim 1 in which the one or more factors relating to the viewer comprises one or more of demographic information, psychographic information, external factors, content context, content popularity, viewer geographic location, and user supplied information.

12. A machine-readable article comprising instructions that when executed by data processing apparatus cause the data processing apparatus to perform operations comprising:
receiving at a content item serving system from a content sponsor a plurality content items and information relating to an impression frequency with which one or more of the content items is to be served by the content item serving system for presentation to a viewer;
maintaining at the content item serving system a history of content items served by the content item serving system for presentation to the viewer;
receiving at the content item serving system a request for content to be served by the content item serving system for presentation to the viewer;
selecting at the content item serving system a content item from among the plurality of received content items based at least in part on the received impression frequency information and the viewer's maintained history; and
providing by the content item serving system the selected content item for presentation to the viewer.

13. The article of claim 12 in which the information relating to impression frequency comprises a skip impression parameter that specifies a quantity of different content item impressions to present before presenting a same content item again to the viewer.

14. The article of claim 12 in which the information relating to impression frequency comprises a set frequency parameter that specifies a quantity of impressions of a same content item to present in succession to the viewer.

15. The article of claim 12 in which the information relating to impression frequency comprises both (i) a skip impression parameter that specifies a quantity of different content item impressions to present before presenting a same content item again to the viewer, and (ii) a set frequency parameter that specifies a quantity of impressions of a same content item to present in succession to the viewer.

16. The article of claim 12 in which all of the content items presented to the viewer originate with a same content sponsor.

17. The article of claim 12 in which one or more of the content items presented to the viewer originate with different content sponsors.

18. The article of claim 12 in which a content item comprises an advertisement to be presented on webpage.

19. The article of claim 12 in which the content sponsor comprises an advertiser.

20. The article of claim 12 in which the data processing apparatus is controlled by an advertising serving company.

21. The article of claim 12 in which impression frequency information received from the content sponsor specifies variable impression frequencies based at least in part on one or more factors relating to the viewer.

22. The article of claim 12 in which the one or more factors relating to the viewer comprises one or more of demographic information, psychographic information, external factors, content context, content popularity, viewer geographic location, and user supplied information.

23. A system comprising:
a processor configured to execute instructions;
memory configured to store instructions for execution by the processor to cause the system to perform operations comprising:
receiving at a content item serving system from a content sponsor a plurality content items and information relating to an impression frequency with which one or more of the content items is to be served by the content item serving system for presentation to a viewer;
maintaining at the content item serving system a history of content items served by the content item serving system for presentation to the viewer;
receiving at the content item serving system a request for content to be served by the content item serving system for presentation to the viewer;
selecting at the content item serving system a content item from among the plurality of received content items based at least in part on the received impression frequency information and the viewer's maintained history; and
providing by the content item serving system the selected content item for presentation to the viewer.

24. The system of claim 23 in which the information relating to impression frequency comprises a skip impression parameter that specifies a quantity of different content item impressions to present before presenting a same content item again to the viewer.

25. The system of claim 23 in which the information relating to impression frequency comprises a set frequency parameter that specifies a quantity of impressions of a same content item to present in succession to the viewer.

26. The system of claim 23 in which the information relating to impression frequency comprises both (i) a skip impression parameter that specifies a quantity of different content item impressions to present before presenting a same content item again to the viewer, and (ii) a set frequency parameter that specifies a quantity of impressions of a same content item to present in succession to the viewer.

27. The system of claim 23 in which all of the content items presented to the viewer originate with a same content sponsor.

28. The system of claim 23 in which one or more of the content items presented to the viewer originate with different content sponsors.

29. The system of claim 23 in which a content item comprises an advertisement to be presented on webpage.

30. The system of claim 23 in which the content sponsor comprises an advertiser.

31. The system of claim 23 in which the system is controlled by an advertising serving company.

32. The system of claim 23 in which impression frequency information received from the content sponsor specifies variable impression frequencies based at least in part on one or more factors relating to the viewer.

33. The system of claim 23 in which the one or more factors relating to the viewer comprises one or more of demographic information, psychographic information, external factors, content context, content popularity, viewer geographic location, and user supplied information.
